(19) United States
(12) Patent Application Publication
(10) Pub. No.: US 2012/0008326 A1
(43) Pub. Date: Jan. 12, 2012

(54) Lighting Device Capable of Reducing the Phenomenon of Melatonin Suppression

(75) Inventor: Jwo-Huei Jou, Taipei City (TW)

(73) Assignee: NATIONAL TSING HUA UNIVERSITY (TAIWAN), Hsinchu (TW)

(21) Appl. No.: 13/078,389

(22) Filed: Apr. 1, 2011

(30) Foreign Application Priority Data
Jul. 9, 2010 (TW) 099122697

(51) Int. Cl. F21V 9/00

(52) U.S. Cl. 362/293

(57) ABSTRACT

According to research, it found that blue light may cause significant effects on suppressing melatonin. For this reason, a lighting device capable of reducing the phenomenon of melatonin suppression is disclosed in the present invention, the lighting device comprises: a light-emitting device being able to emit a visible light; and a light-filtering device being close to the light-emitting device, wherein when the light-emitting device emits the visible light, the light-filtering device is able to filter a blue light component of the visible light, so as to reduce the blue light component within the visible light emitted by the light-emitting device, then the effects on suppressing the melatonin caused by the visible light are reduced.

### BACKGROUND OF THE INVENTION

1. Field of the Invention

The present invention relates to a lighting device, and more particularly to a lighting device having a light-filtering device for filtering a blue light component of a visible light emitted by a light-emitting device, so as to reduce the phenomenon of melatonin suppression.

2. Description of the Prior Art

Melatonin is secreted by a gland of Pineal body in human brain, and it has the following influences on physiological functions of human: (1) promoting sleep: melatonin has the effect of hypnogenesis, and contributes to sleep; (2) affecting emotion: the lack of melatonin for a long time will lead to the occurrence of mood disorders; (3) sexual maturity and reproduction: melatonin can affect hypothalamus on secreting gonadal releasing hormones, and also can affect the effect of gonadal releasing hormones on pituitary gland; and (4) affecting the immune functions: melatonin can induce the synthesis of T lymphocytes and the release of interlukin-2 (IL-2) and interlukin-4 (IL-4), so as to increase the immunity of human body.

Through researches, it has been found that the production and the secretion of melatonin mainly influenced by the following three factors: (A) light: light is transmitted to hypothalamus through retinal nerves, and then transmitted to pineal body through the sympathetic nerves, so as to inhibit the secretion of melatonin, thus the secretion of melatonin can be inhibited in higher level under the darker environment; (B) circadian rhythm: hypothalamus, is like a biological clock, can affect the secretion of melatonin, so that the concentration of melatonin secreted by pineal body has a significant variation according to circadian rhythm, and the concentration of melatonin in blood in the night is 6 times higher than that in the day according to researches; and (C) electromagnetic wave: an electromagnetic wave can inhibit the ability of pineal body for synthesizing melatonin, and the electromagnetic wave also can inhibit the activity of the synthesis of melatonin.

However, light is indispensable in a daily life. The light perceivable by human eyes is called visible light, wherein the major natural light is sunlight, and the artificial light has various kinds, such as candlelight, incandescent lamps, fluorescent lamps, LED lamp, and OLED lamps. Referring to the following Table 1, the color components and the wavelength range thereof of the visible light in a vacuum state are illustrated. Generally speaking, the wavelength range of the visible light is about 450 nm to 750 nm; the color components of the visible light include red, orange, yellow, green, blue, and purple, wherein red, green and blue are often applied to artificial white light source.

TABLE 1

| Color | Wavelength (nm) |
|---|---|
| Red | 622~780 |
| Orange | 597~622 |
| Yellow | 577~597 |
| Green | 492~577 |
| Blue | 455~492 |
| Purple | 390~455 |

Referring to FIG. 1, which is a scatter diagram of the relative sensitivity of melatonin under different wavelengths of a visible light. Obviously, as shown in FIG. 1, melatonin has a higher sensitivity under short wavelengths of visible light than long wavelengths of visible light. Wherein the relative sensitivity of melatonin in FIG. 1 has been normalized based on wavelength of 480 nm, and the related data are from the following three references: (1) George C. Brainard, John P. Hanifin, Jeffrey M. Greeson, Brenda Byrne, Gena Glickman, Edward Gerner, and Mark D. Rollag, “Action Spectrum for Melatonin Regulation in Humans: Evidence for a Novel Circadian Photoreceptor,” Journal of Neuroscience, 21(16), pp. 6405-6412, August, 2001; (2) K. Thapan, J. Arendt, and D. J Skene, “An action spectrum for melatonin suppression: evidence for a novel non-rod, non-cone photoreceptor system in humans,” Journal of Physiology, 535, pp. 261-267, 2008; and (3) John P. Hanifin, Karen T. Stewart, Peter Smith, Roger Tanner, Mark Rollag and George C. Brainard, “High intensity red light suppresses melatonin,” Chronobiology International, Vol. 23, No. 1-2, pp. 251-268, 2006.

Referring to the following Table 2 and Table 3, Table 2 presents the sensitivity of melatonin to different wavelengths of visible light in the above reference 1, and Table 3 presents the sensitivity of melatonin to different wavelengths of visible light in the above reference 2.

TABLE 2

| wavelengths | Relative | Normalized value of |
|---|---|---|
| (nm) | sensitivity | relative sensitivity |
| 440 | 1 | 1.54 |
| 460 | 0.97 | 1.49 |
| 480 | 0.65 | 1 |
| 505 | 0.65 | 1 |
| 530 | 0.295 | 0.45 |
| 555 | 0.071 | 0.11 |
| 575 | 0038 | 0.06 |
| 600 | 0.019 | 0.03 |

TABLE 3

| wavelengths | Relative | Normalized value of |
|---|---|---|
| (nm) | sensitivity | relative sensitivity |
| 424 | 0 | 3.52 |
| 456 | −0.32 | 1.69 |
| 472 | −0.46 | 1.22 |
| 496 | −0.72 | 0.67 |
| 520 | −0.85 | 0.5 |
| 548 | −1.73 | 0.15 |

As shown in Table 2, the relative sensitivity of melatonin to 440 nm is 1, the relative sensitivity of melatonin to 460 nm is 0.97, and the relative sensitivity of melatonin to 480 nm is 0.65; it can be seen from Table 1 that the visible light under 440 nm is purple light, and the visible light under 460 nm and 480 nm is blue light. As shown in Table 3, the relative sensitivity of melatonin to 424 nm is 0, the relative sensitivity of melatonin to 456 nm is −0.32, and the relative sensitivity of melatonin to 472 nm is −0.46; it can be seen from Table 1 that the visible light under 424 nm is purple light, and the visible light under 456 nm and 472 nm is blue light.

Through the above results, melatonin has a highest sensitivity to purple light, and melatonin has a lower sensitivity to blue light; generally speaking, purple light is not applied in the artificial light source, but blue and red light are often mixed and then utilized to the artificial white light. Thus the white lighting devices, such as an incandescent lamp, a LED lamp and an OLED lamp, all contain the component of blue light. Furthermore, owing to the sensitivity of melatonin to blue light is very high, if human body is exposed in blue light for a long period, the phenomenon of the suppression of melatonin might be caused, and insomnia and mood disorders can be further induced. Besides the incandescent lamp, the LED lamp and the OLED lamp, other lighting devices, such as candlelight and a fluorescent lamp, may emit visible light containing blue light component. Thus, if a human body is emitted by the candlelight and the fluorescent lamp for a long time, the phenomenon of the suppression of melatonin also might be caused.

In view of this, it is necessary to provide a lighting device capable of reducing the phenomenon of melatonin suppression, and the shortcomings in the conventional lighting devices can be overcome.

### SUMMARY OF THE INVENTION

The major objective of the present invention is to provide a lighting device capable of reducing the phenomenon of melatonin suppression, wherein a light-emitting device is provided with a light-filtering device which can filter a visible light emitted by the light-emitting device and then reduce a blue light component of the visible light, so as to reduce the phenomenon of melatonin suppression caused by the visible light emitted by the light-emitting device.

According to the above objective, the present invention provides the lighting device capable of reducing the phenomenon of melatonin suppression comprising: a light-emitting device having a light-emitting end, which is able to emit a visible light; and a light-filtering device being close to the light-emitting device, wherein when the light-emitting device emits the visible light, the light-filtering device being able to filter a blue light component of the visible light; wherein when the visible light emitted by the light-emitting device contains a purple light component with a shorter wavelength, the light-filtering device being able to filter the purple light component simultaneously.

Further objective of the present invention is to provide a lighting device capable of reducing the phenomenon of melatonin suppression, wherein a light-emitting device is provided with a wavelength converting device which can absorb and convert the wavelength of a visible light emitted by the light-emitting device and then convert a blue light component of the visible light into the visible light with a long wavelength, so as to reduce the phenomenon of melatonin suppression caused by the visible light emitted by the light-emitting device.

According to the above objective, the present invention provides the lighting device capable of reducing the phenomenon of melatonin suppression comprising: a light-emitting device having a light-emitting end, which is able to emit a visible light; and a wavelength converting device being close to the light-emitting device, wherein when the light-emitting device emits the visible light, the wavelength converting device being able to absorb a blue light component of the visible light and convert the blue light component with a short wavelength into the visible light with a long wavelength; wherein when the visible light emitted by the light-emitting device contains a purple light component with a shorter wavelength, the wavelength converting device being able to absorb and convert the short wavelength of the purple light component.

### BRIEF DESCRIPTION OF THE DRAWINGS

For a complete understanding of the aspects, structures and techniques of the invention, reference should be made to the following detailed description and accompanying drawings wherein:

FIG. 1 is a scatter diagram of the relative sensitivity of melatonin under different wavelengths of a visible light;

FIG. 2A is a schematic diagram of a lighting device capable of reducing the phenomenon of melatonin suppression according to a first preferred embodiment of the present invention;

FIG. 2B is a schematic diagram of the lighting device capable of reducing the phenomenon of melatonin suppression according to a second preferred embodiment of the present invention;

FIG. 2C is a schematic diagram of the lighting device capable of reducing the phenomenon of melatonin suppression according to a third preferred embodiment of the present invention;

FIG. 3 is a schematic diagram of a first experiment of the present invention;

FIG. 4 is a schematic diagram of a second experiment of the present invention;

FIG. 5 is a luminescence spectra diagram of a visible light emitted by a candle;

FIG. 6 is a luminescence spectra diagram of a visible light emitted by an incandescent bulb;

FIG. 7 is a luminescence spectra diagram of a visible light emitted by a warm fluorescent lamp;

FIG. 8 is a luminescence spectra diagram of a visible light emitted by a cold fluorescent lamp;

FIG. 9 is a luminescence spectra diagram of a visible light emitted by a LED lamp;

FIG. 10 is a luminescence spectra diagram of a visible light emitted by an OLED lamp;

FIG. 11A is a schematic diagram of the lighting device capable of reducing the phenomenon of melatonin suppression according to a fourth preferred embodiment of the present invention;

FIG. 11B is a schematic diagram of the lighting device capable of reducing the phenomenon of melatonin suppression according to a fifth preferred embodiment of the present invention;

FIG. 11C is a schematic diagram of the lighting device capable of reducing the phenomenon of melatonin suppression according to a sixth preferred embodiment of the present invention;

FIG. 12 is a perspective diagram of a liquid crystal display (LCD) with a light-filtering device;

FIG. 13 is a perspective diagram of a cellular phone with the light-filtering device;

FIG. 14 is an exploded diagram of the LCD; and

FIG. 15 is an exploded diagram of the cellular phone.

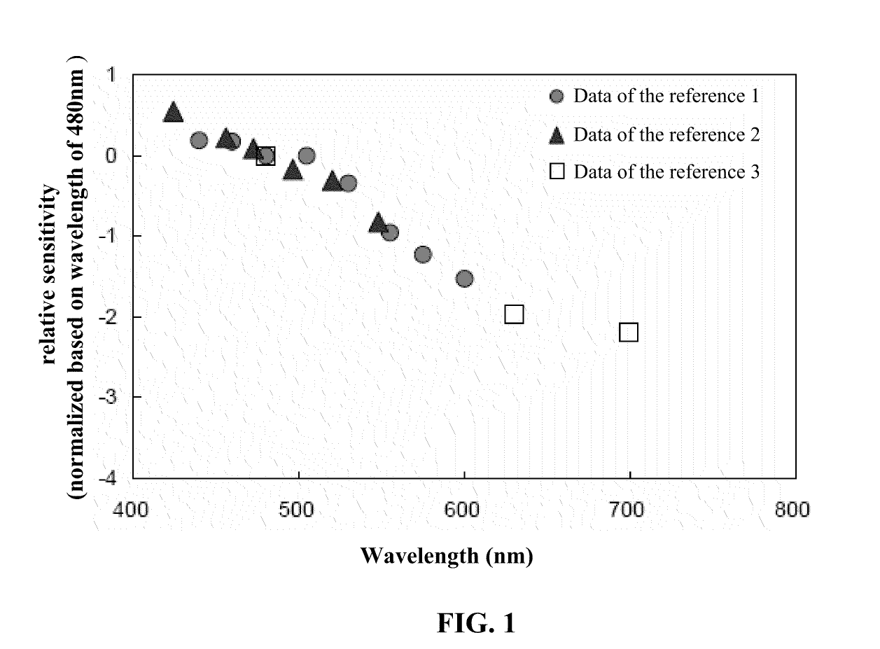

### DETAILED DESCRIPTION OF THE PREFERRED EMBODIMENTS

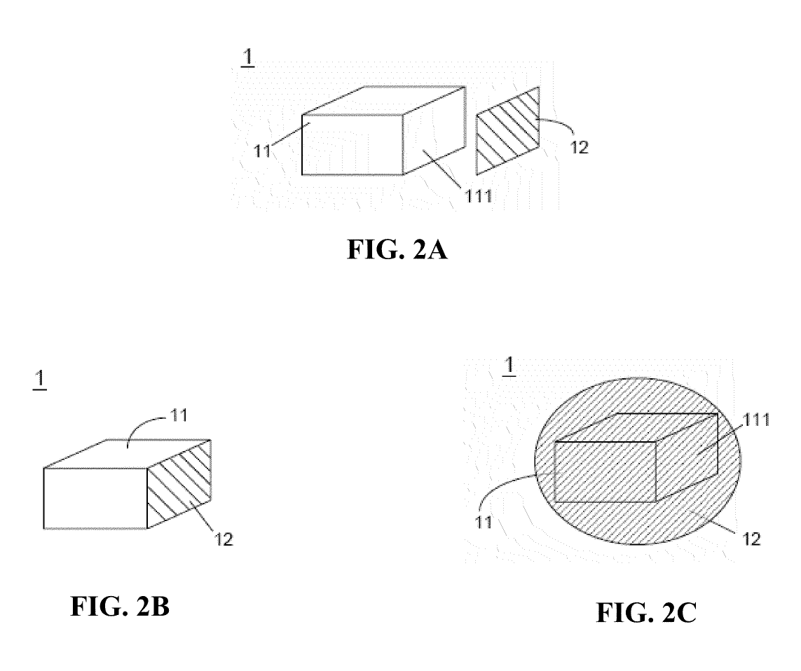

Referring to FIG. 2A, FIG. 2B and FIG. 2C, wherein FIG. 2A is a schematic diagram of a lighting device capable of reducing the phenomenon of melatonin suppression according to a first preferred embodiment of the present invention, FIG. 2B is a schematic diagram of the lighting device capable of reducing the phenomenon of melatonin suppression according to a second preferred embodiment of the present invention, and FIG. 2C is a schematic diagram of the lighting device capable of reducing the phenomenon of melatonin suppression according to a third preferred embodiment of the present invention. The lighting device capable of reducing the phenomenon of melatonin suppression 1 includes: a light-emitting device 11 having a light-emitting end 111, which is able to emit a visible light; and a light-filtering device 12 being close to the light-emitting device 11, wherein when the light-emitting device 11 emits the visible light, the light-filtering device 12 being able to filter a blue light component of the visible light; wherein when the visible light emitted by the light-emitting device 11 contains a purple light component and a green light component with a shorter wavelength, the light-filtering device 12 being able to filter the purple light component and the green light component simultaneously. The above-mentioned light-emitting device 11 can be any of the following: an incandescent lamp, a LED lamp, an OLED lamp, a fluorescent lamp, or candlelight. The material of the light-filtering device 12 can be any of the following: a filter slice, a filter paper or a filter membrane.

As shown in FIG. 2A, the light-filtering device 12 of the first preferred embodiment is disposed at the front of the light-emitting end 111 of the light-emitting device 11, so as to receive and filter the blue light component of the visible light; as shown in FIG. 2B, the light-filtering device 12 of the second preferred embodiment is adhere to the surface of the light-emitting end 111 of the light-emitting device 11, so as to receive and filter the blue light component of the visible light; as shown in FIG. 2C, the light-filtering device 12 of the third preferred embodiment is surround and cover the entire light-emitting device 11, and the light-emitting device 11 and the light-filtering device 12 together constitute the lighting device capable of reducing the phenomenon of melatonin suppression 1 of the present invention.

The technical feature of the present invention is to combine the light-emitting device 11 and the light-filtering device 12, so as to constitute the lighting device capable of reducing the phenomenon of melatonin suppression 1, wherein the light-filtering device 12 can filter the blue light component emitted by the light-emitting device 11. Comparing to the conventional lighting devices, such as the candle, the incandescent lamp, the fluorescent lamp, the LED lamp, and the OLED lamp, the lighting device capable of reducing the phenomenon of melatonin suppression 1 of the present invention can emit the visible light which affects the phenomenon of melatonin suppression to a very low extent.

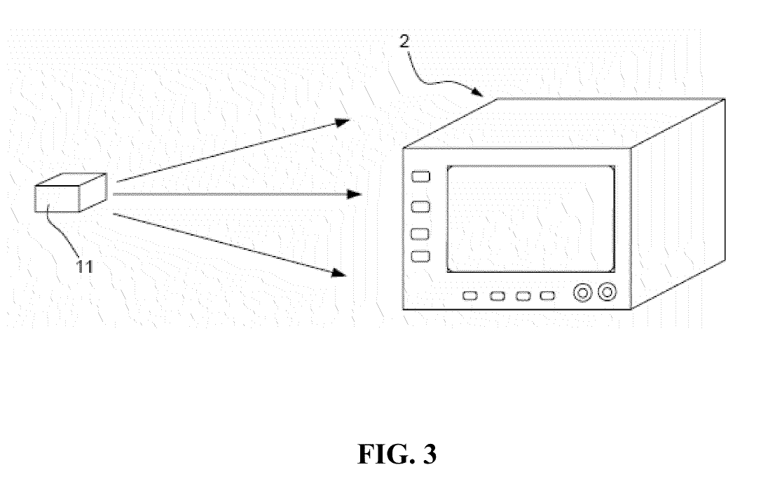

In order to prove that the lighting device capable of reducing the phenomenon of melatonin suppression 1 of the present invention has the practicability, the following experiments combine the light-filtering device 12 with different light-emitting devices 11, and then obtain the luminescence spectra of the visible light emitted by the different light-emitting devices 11 combined with the light-filtering device 12 as well as the influences of the phenomenon of melatonin suppression. Referring to FIG. 3, which is a schematic diagram of a first experiment of the present invention. In the first experiment, the light-emitting devices 11 and a spectral scanning device 2 are utilized, wherein the spectral scanning device 2 can measure the spectrum of the visible light emitted by the light-emitting devices 11. In the measurement, the light-emitting devices 11 under test are fixed and kept separate from the spectral scanning device 2 for a specific distance. Subsequently, setting the focal distance of the spectral scanning device 2 for measuring the spectrum, so as to obtain the luminescence spectra of the visible light of different light-emitting devices 11, such as the candle, the incandescent lamp, the fluorescent lamp, the LED lamp, and the OLED lamp, by the first experiment, as well as to obtain the influence of the phenomenon of melatonin suppression by the visible light emitted by these light-emitting devices 11.

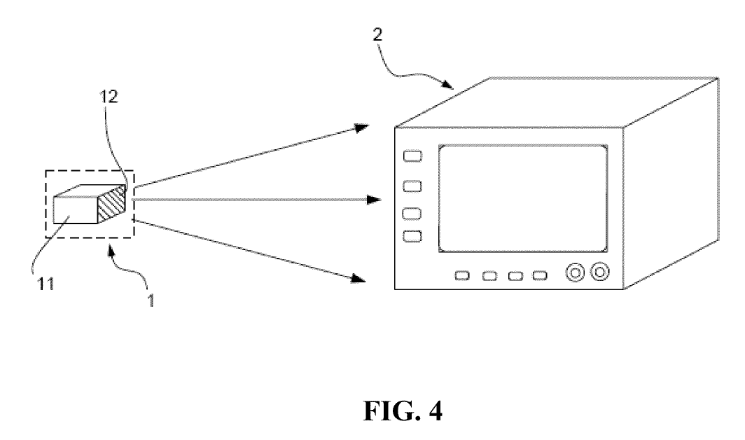

Referring to FIG. 4, which is a schematic diagram of a second experiment of the present invention. In the second experiment, the light-emitting devices 11, the light-filtering device 12 and the spectral scanning device 2 are utilized, wherein the light-filtering device 12 adheres to the surface of the light-emitting end 111 of the light-emitting device 11, and the light-emitting device 11 and the light-filtering device 12 together constitute the lighting device capable of reducing the phenomenon of melatonin suppression 1 of the present invention. The material of the light-filtering device 12 is a filter slice, which can filter the blue light component in the visible light. In the second experiment, the visible light with longer wavelength can pass through the filter slice directly, and the visible light with shorter wavelength is filtered out by the filter slice; similarly, when measure the luminescence spectra of the visible light emitted by the light-emitting device 11, the light-emitting devices 11 under test and the light-filtering device 12 are fixed and kept separate from the spectral scanning device 2 for a specific distance. Subsequently, set the focal distance of the spectral scanning device 2 for measuring the spectrum, so as to obtain the luminescence spectra of the visible light of different light-emitting devices 11 by the first experiment, as well as to obtain the influence of the phenomenon of melatonin suppression by the visible light without the blue light component.

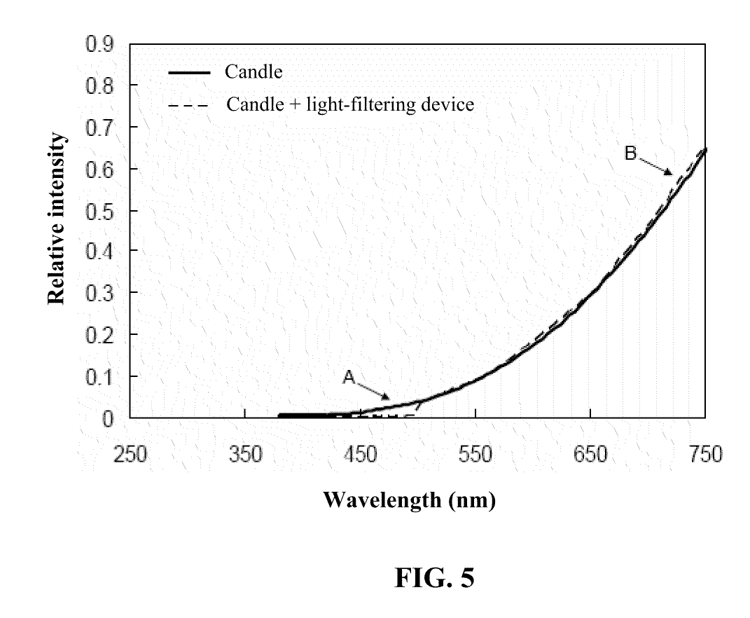

Referring to FIG. 5, which is a luminescence spectra diagram of a visible light emitted by a candle. In the figure, curve A presents the luminescence spectra of the visible light emitted by the candle, and curve B presents the luminescence spectra of the visible light emitted by the candle which is filtered out the blue light component by the light-filtering device 12. As shown in the following Table 4, through the curve A and the data obtained by the spectral scanning device 2, it can be calculated that the Color Rendering Index (CRI) of the visible light emitted by the candle is 86, the Correlated Color Temperature (CCT) is 1970K, and the Melatonin Suppression Fluence-Response (MSF) is 6%; through the curve B and the data obtained by the spectral scanning device 2, it can be calculated that the CRI of the visible light filtered by the light-filtering device 12 is 73, the CCT is 1870K, and the MSF is 3%.

TABLE 4

| Light source | CRI | CCT (K) | MSF (%) |
|---|---|---|---|
| Candle | 86 | 1970 | 6 |
| Candle + light- | 73 | 1870 | 3 |
| filtering device | | | |

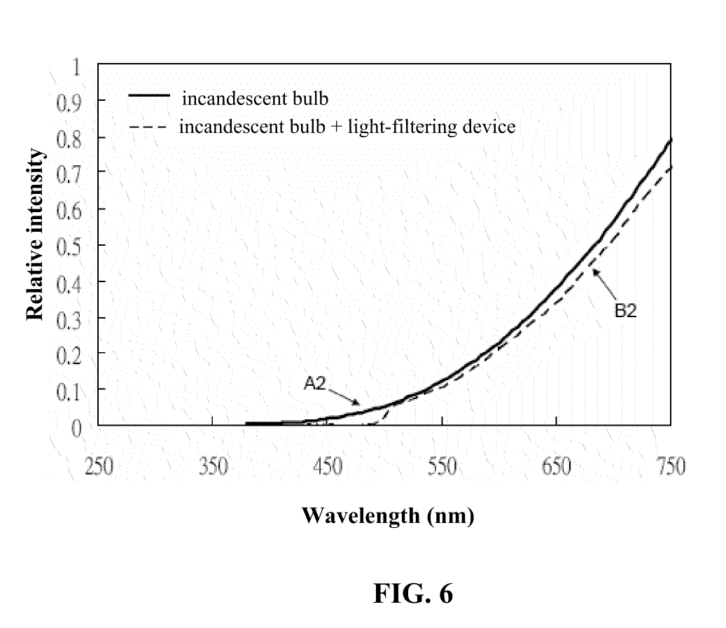

Referring to FIG. 6, which is a luminescence spectra diagram of a visible light emitted by an incandescent bulb. In the figure, curve A2 presents the luminescence spectra of the visible light emitted by the incandescent bulb, and curve B2 presents the luminescence spectra of the visible light emitted by the incandescent bulb which is filtered out the blue light component by the light-filtering device 12. As shown in the following Table 5, through the curve A2 and the data obtained by the spectral scanning device 2, it can be calculated that the CRI of the visible light emitted by the incandescent bulb is 89, the CCT is 2000K, and the MSF is 7%; through the curve B2 and the data obtained by the spectral scanning device 2, it can be calculated that the CRI of the visible light filtered by the light-filtering device 12 is 75, the CCT is 1900K, and the MSF is 3%.

TABLE 5

| Light source | CRI | CCT (K) | MSF (%) |
|---|---|---|---|
| incandescent bulb | 89 | 2000 | 7 |
| incandescent bulb + | 75 | 1900 | 3 |
| light-filtering device | | | |

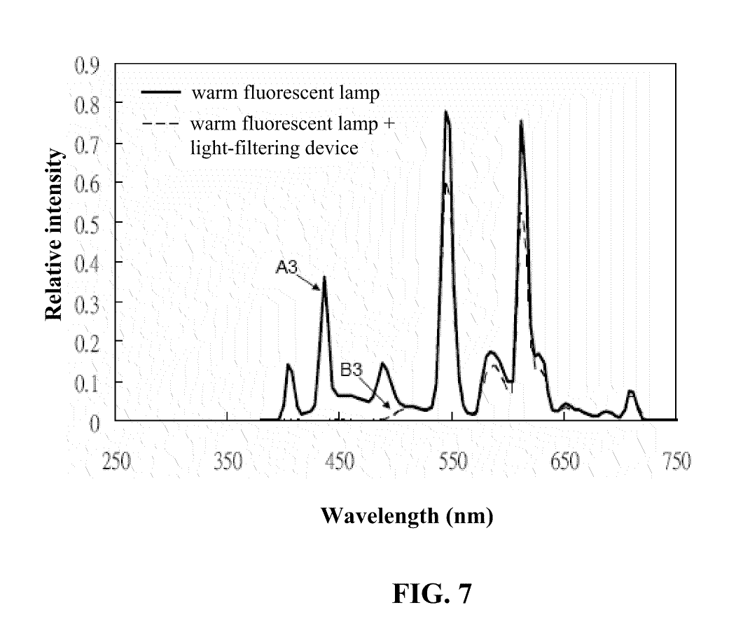

Referring to FIG. 7, which is a luminescence spectra diagram of a visible light emitted by a warm fluorescent lamp. In the figure, curve A3 presents the luminescence spectra of the visible light emitted by the warm fluorescent lamp, and curve B3 presents the luminescence spectra of the visible light emitted by the warm fluorescent lamp which is filtered out the blue light component by the light-filtering device 12. As shown in the following Table 6, through the curve A3 and the data obtained by the spectral scanning device 2, it can be calculated that the CRI of the visible light emitted by the warm fluorescent lamp is 82, the CCT is 3700K, and the MSF is 71%; through the curve B3 and the data obtained by the spectral scanning device 2, it can not be calculated the CRI and the CCT value, but the MSF is merely 13%.

TABLE 6

| Light source | CRI | CCT (K) | MSF (%) |
|---|---|---|---|
| warm fluorescent lamp | 82 | 3700 | 71 |
| warm fluorescent lamp + | None | None | 13 |
| light-filtering device | | | |

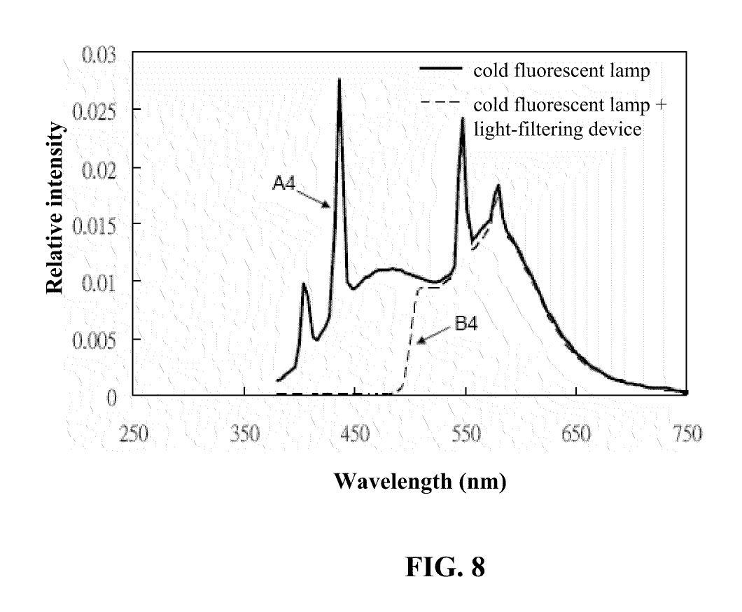

Referring to FIG. 8, which is a luminescence spectra diagram of a visible light emitted by a cold fluorescent lamp. In the figure, curve A4 presents the luminescence spectra of the visible light emitted by the cold fluorescent lamp, and curve B4 presents the luminescence spectra of the visible light emitted by the cold fluorescent lamp which is filtered out the blue light component by the light-filtering device 12. As shown in the following Table 7, through the curve A4 and the data obtained by the spectral scanning device 2, it can be calculated that the CRI of the visible light emitted by the cold fluorescent lamp is 71, the CCT is 5800K, and the MSF is 102%; through the curve B4 and the data obtained by the spectral scanning device 2, it can not be calculated the CRI and the CCT value, but the MSF is merely 17%.

TABLE 7

| Light source | CRI | CCT (K) | MSF (%) |
|---|---|---|---|
| cold fluorescent lamp | 71 | 5800 | 102 |
| cold fluorescent lamp + | None | None | 17 |
| light-filtering device | | | |

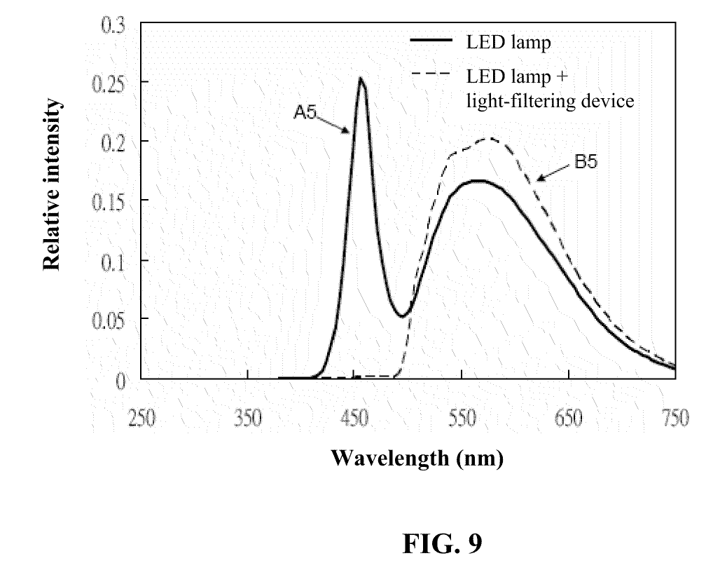

Referring to FIG. 9, which is a luminescence spectra diagram of a visible light emitted by a LED lamp. In the figure, curve A5 presents the luminescence spectra of the visible light emitted by the LED lamp, and curve B5 presents the luminescence spectra of the visible light emitted by the LED lamp which is filtered out the blue light component by the light-filtering device 12. As shown in the following Table 8, through the curve A5 and the data obtained by the spectral scanning device 2, it can be calculated that the CRI of the visible light emitted by the LED lamp is 81, the CCT is 5000K, and the MSF is 56%; through the curve B5 and the data obtained by the spectral scanning device 2, it can not be calculated the CRI and the CCT value, but the MSF is merely 14%.

TABLE 8

| Light source | CRI | CCT (K) | MSF (%) |
|---|---|---|---|
| LED lamp | 81 | 5000 | 56 |
| LED lamp + light- | None | None | 14 |
| filtering device | | | |

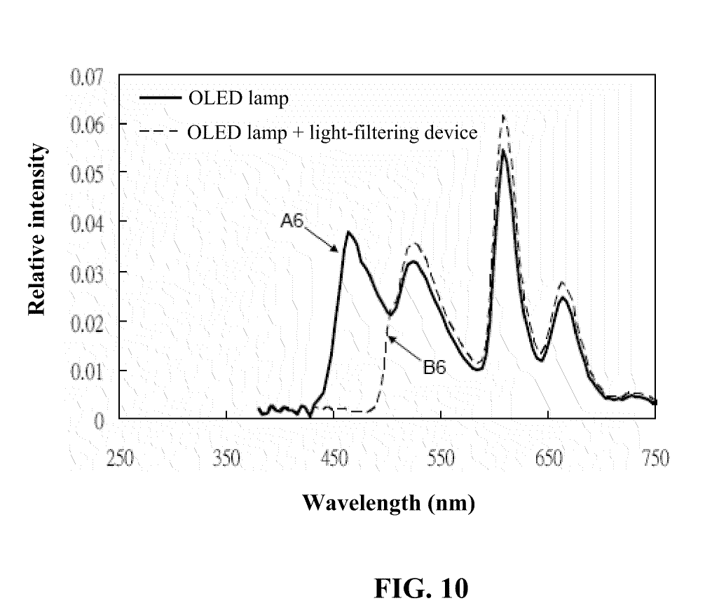

Referring to FIG. 10, which is a luminescence spectra diagram of a visible light emitted by an OLED lamp. In the figure, curve A6 presents the luminescence spectra of the visible light emitted by the OLED lamp, and curve B6 presents the luminescence spectra of the visible light emitted by the OLED lamp which is filtered out the blue light component by the light-filtering device 12. As shown in the following Table 9, through the curve A6 and the data obtained by the spectral scanning device 2, it can be calculated that the CRI of the visible light emitted by the OLED lamp is 81, the CCT is 5000K, and the MSF is 56%; through the curve B6 and the data obtained by the spectral scanning device 2, it can not be calculated the CRI and the CCT value, but the MSF is merely 27%.

TABLE 9

| Light source | CRI | CCT (K) | MSF (%) |
|---|---|---|---|
| OLED lamp | 81 | 4800 | 52 |
| OLED lamp + light- | None | None | 27 |
| filtering device | | | |

Combining the above results, it can be seen that the adherence of the light-filtering device 12 to the light-emitting end 111 of the light-emitting device 11 can make the blue light component of the visible light emitted by the light-emitting device 11 been filtered out by the light-filtering device, and then the phenomenon of melatonin suppression can be reduced by the visible light emitted by the light-emitting device 11 significantly.

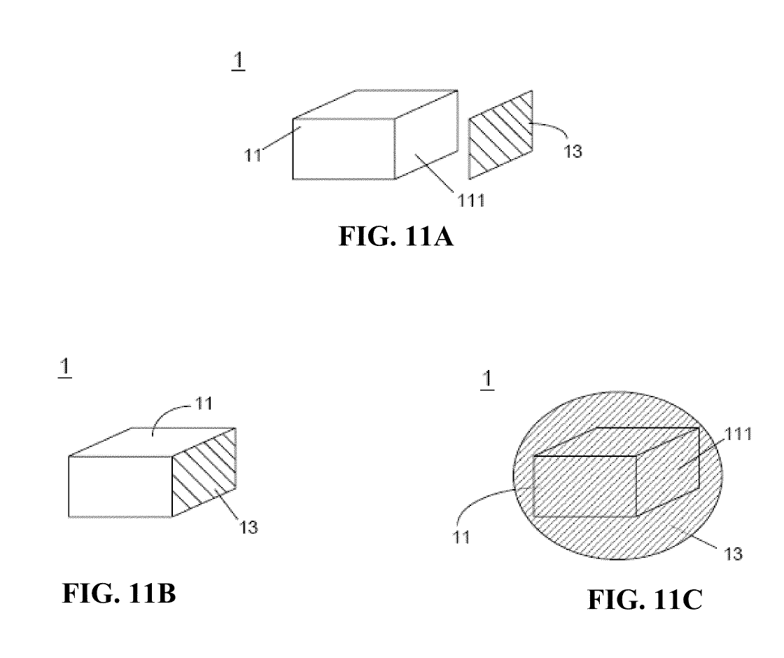

Besides the manner of filtering out the blue light component, the blue light component with shorter wavelength can be converted into the visible light with longer wavelength by the manner of wavelength conversion. Referring to FIG. 11A, FIG. 11B and FIG. 11C, wherein FIG. 11A is a schematic diagram of the lighting device capable of reducing the phenomenon of melatonin suppression according to a fourth preferred embodiment of the present invention, FIG. 11B is a schematic diagram of the lighting device capable of reducing the phenomenon of melatonin suppression according to a fifth preferred embodiment of the present invention, and FIG. 11C is a schematic diagram of the lighting device capable of reducing the phenomenon of melatonin suppression according to a sixth preferred embodiment of the present invention. As shown in FIG. 11A, a wavelength converting device 13 is disposed at the front of the light-emitting end 111 of the light-emitting device 11, so as to absorb the blue light component of the visible light and convert the blue light component with shorter wavelength into the visible light with longer wavelength; as shown in FIG. 11B, the wavelength converting device 13 is adhere to the surface of the light-emitting end 111 of the light-emitting device 11, so as to absorb and convert the blue light component of the visible light; as shown in FIG. 11C, the wavelength converting device 13 is surround and cover the entire light-emitting device 11, when the light-emitting device 11 emits the visible light, the wavelength converting device 13 can absorb the blue light component and then convert the blue light component with shorter wavelength into the visible light with longer wavelength. Furthermore, the light-emitting device 11 and the wavelength converting device 13 of FIG. 11A, FIG. 11B and FIG. 11C together constitute the lighting device capable of reducing the phenomenon of melatonin suppression 1 of the present invention. Wherein when the visible light emitted by the light-emitting device 11 has the purple light component and the green light component with shorter wavelength, the wavelength converting device 13 can absorb and convert the purple light component and the green light component simultaneously.

In fact, the major spirit of the present invention is to filter or convert the wavelength of the light components with shorter wavelength, such as the green light component, the blue light component and the purple light component, of the visible light by the light-filtering device 12 or the wavelength converting device 13, so as to remove the light components with shorter wavelength of the visible light, and avoid the phenomenon of melatonin suppression happening caused by the light components with shorter wavelength; thus, if the visible light is a natural light which has the light components with shorter wavelength, the light-filtering device 12 and the wavelength converting device 13 can be made into glasses or a shadow mask for a user to wear, and the light components with shorter wavelength separated from eyes of the human body, so as to reduce the phenomenon of melatonin suppression.

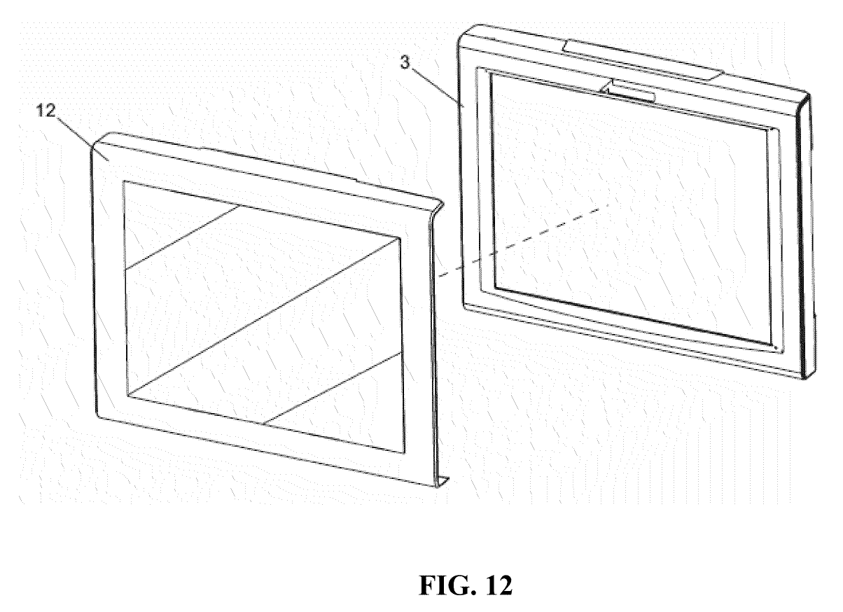

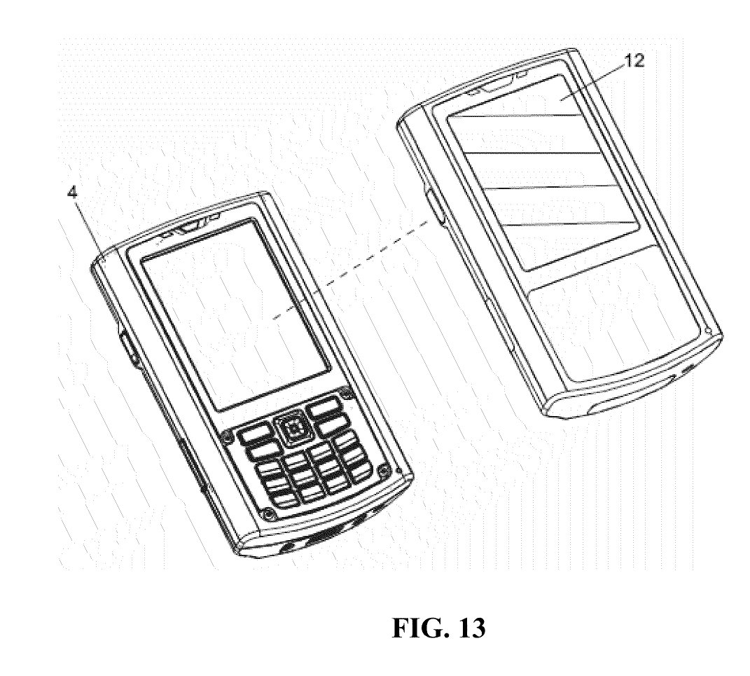

Additionally, the visible light can be emitted by a television, a computer screen, a cellular phone, or a multimedia player. If the visible light emitted by the television, the computer screen, the cellular phone, or the multimedia player contains the green light component, the blue light component or the purple light component, the light-filtering device 12 or the wavelength converting device 13 can be used to filter or convert the wavelength of the light components with shorter wavelength of the visible light, so as to remove the light components with shorter wavelength of the visible light. In practice, the light-filtering device 12 and the wavelength converting device 13 are made into the structure suitable to be installed on the television, the computer screen, the cellular phone, or the multimedia player. Referring to FIG. 12, which is a perspective diagram of a liquid crystal display (LCD) with a light-filtering device, wherein the LCD 3 can be used as the television or the computer screen. Referring to FIG. 13, which is a perspective diagram of a cellular phone with the light-filtering device. As shown in FIG. 12 and FIG. 13, the light-filtering device 12 and the wavelength converting device 13 are made into the structure suitable to be installed on the LCD 3 or the cellular phone 4. If necessary, the user can dispose the light-filtering device 12 or the wavelength converting device 13 on the LCD 3 or the cellular phone 4, so as to remove the light components with shorter wavelength of the visible light.

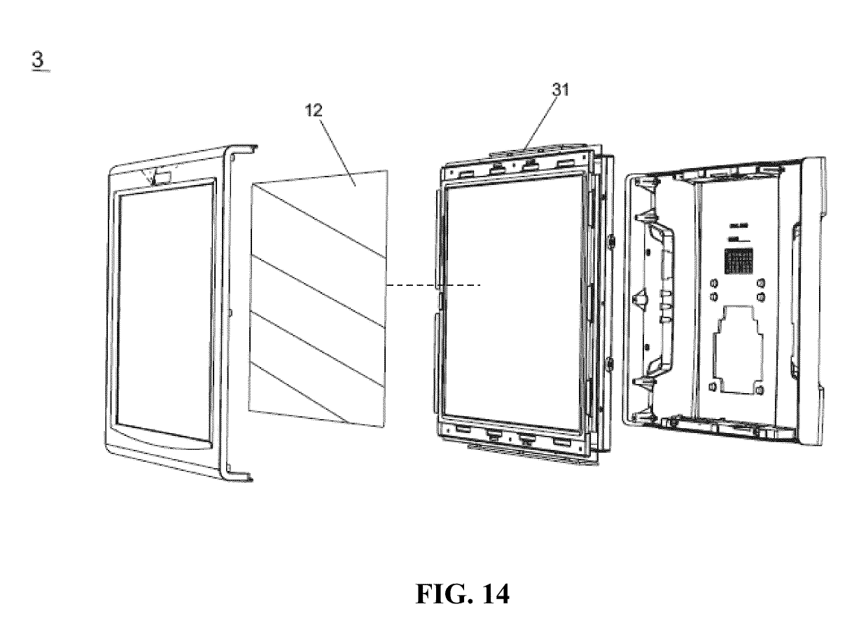

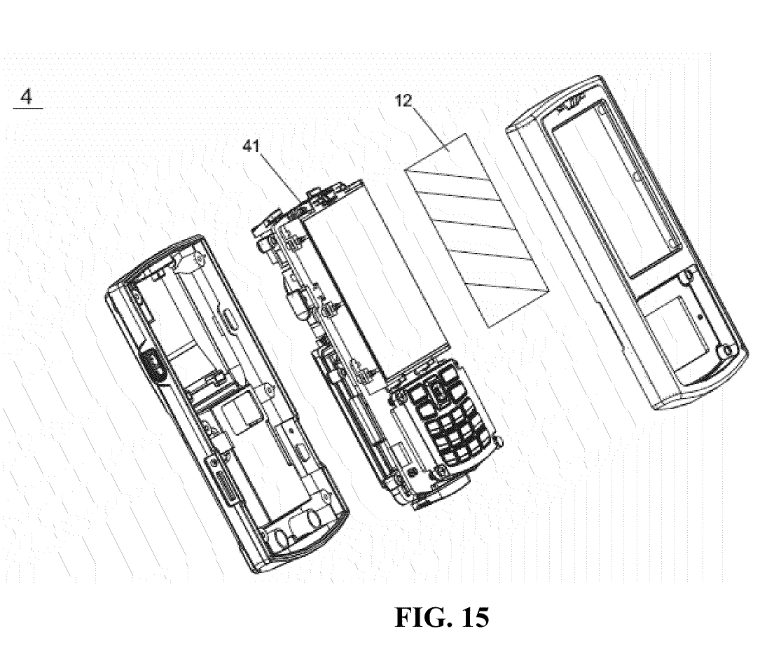

Furthermore, most of the commercial television, computer screen, cellular phone, and multimedia player have the LCD screen. In the LCD screen, the light transmittance of each pixel position can be controlled through a liquid crystal layer of a LCD panel, so that the LCD screen can display images correctly; however, owing to the LCD panel of the LCD screen is not made of a non-self-luminous material, the LCD screen usually needs to be provided with an external light source and an optical device, such as a backlight module; in the conventional backlight module of the LCD screen, the light source is LED, and the design of the optical device is utilized to enhance the control of the direction of light. Thus, in order to filter out the light components with shorter wavelength of the visible light, the light-filtering device 12 or the wavelength converting device 13 is disposed on the backlight module when the backlight module is fabricated, and the effect of removing the light components with shorter wavelength of the visible light also can be achieved. Referring to FIG. 14 and FIG. 15, FIG. 14 is an exploded diagram of the LCD, and FIG. 15 is an exploded diagram of the cellular phone. As shown in FIG. 14, the light-filtering device 12 can be disposed on the backlight module 31 of the LCD screen 3 with the form of a panel; as shown in FIG. 15, the light-filtering device 12 also can be disposed on the backlight module 41 of the cellular phone 4 with the form of a panel.

It should be understood that the embodiments of the present invention described herein are merely illustrative of the technical concepts and features of the present invention and are not meant to limit the scope of the invention. Those skilled in the art, after reading the present disclosure, will know how to practice the invention. Various variations or modifications can be made without departing from the spirit of the invention. All such equivalent variations and modifications are intended to be included within the scope of the invention.

As a result of continued thinking about the invention and modifications, the inventors finally work out the designs of the present invention that has many advantages as described above. The present invention meets the requirements for an invention patent, and the application for a patent is duly filed accordingly. It is expected that the invention could be examined at an early date and granted so as to protect the rights of the inventors.

What is claimed is:

1. A lighting device capable of reducing the phenomenon of melatonin suppression comprising:
a light-emitting device having a light-emitting end, which is able to emit a visible light; and
a light-filtering device being close to the light-emitting device, wherein when the light-emitting device emits the visible light, the light-filtering device being able to filter a blue light component of the visible light;
wherein when the visible light emitted by the light-emitting device contains a purple light component with a shorter wavelength, the light-filtering device being able to filter the purple light component simultaneously.

2. The lighting device capable of reducing the phenomenon of melatonin suppression according to claim 1, wherein the light-emitting device is selected from the group consisting of: an incandescent lamp, a LED lamp, an OLED lamp, a fluorescent lamp, and candlelight.

3. The lighting device capable of reducing the phenomenon of melatonin suppression according to claim 1, wherein the material of the light-filtering device is selected from the group consisting of: a filter slice, a filter paper and a filter thin film.

4. The lighting device capable of reducing the phenomenon of melatonin suppression according to claim 1, wherein the light-filtering device is able to adhere to the surface of the light-emitting end of the light-emitting device.

5. The lighting device capable of reducing the phenomenon of melatonin suppression according to claim 1, wherein the light-filtering device is disposed at the front of the light-emitting end of the light-emitting device.

6. The lighting device capable of reducing the phenomenon of melatonin suppression according to claim 1, wherein the light-filtering device is able to surround and cover the entire light-emitting device.

7. The lighting device capable of reducing the phenomenon of melatonin suppression according to claim 1, wherein the light-filtering device is able to filter a green light component.

8. A lighting device capable of reducing the phenomenon of melatonin suppression comprising:
a light-emitting device having a light-emitting end, which is able to emit a visible light; and
a wavelength converting device being close to the light-emitting device, wherein when the light-emitting device emits the visible light, the wavelength converting device being able to absorb a blue light component of the visible light and convert the blue light component with a short wavelength into the visible light with a long wavelength;
wherein when the visible light emitted by the light-emitting device contains a purple light component with a shorter wavelength, the wavelength converting device being able to absorb and convert the short wavelength of the purple light component.

9. The lighting device capable of reducing the phenomenon of melatonin suppression according to claim 8, wherein the light-emitting device is selected from the group consisting of: an incandescent lamp, a LED lamp, an OLED lamp, a fluorescent lamp, and candlelight.

10. The lighting device capable of reducing the phenomenon of melatonin suppression according to claim 8, wherein the wavelength converting device is able to adhere to the surface of the light-emitting end of the light-emitting device.

11. The lighting device capable of reducing the phenomenon of melatonin suppression according to claim 8, wherein the wavelength converting device is disposed at the front of the light-emitting end of the light-emitting device.

12. The lighting device capable of reducing the phenomenon of melatonin suppression according to claim 8, wherein the wavelength converting device is able to surround and cover the entire light-emitting device.

13. The lighting device capable of reducing the phenomenon of melatonin suppression according to claim 8, wherein the wavelength converting device is able to convert the wavelength of a green light component of the visible light.
